(19) United States
(12) Patent Application Publication
(10) Pub. No.: US 2008/0190065 A1
(43) Pub. Date: Aug. 14, 2008

(54) HURRICANE PANEL HOOK

(76) Inventors: Paul M. Craig, Hyannis, MA (US); Paul Bodensiek, Attleboro, MA (US)

Correspondence Address: CESARI AND MCKENNA, LLP, 88 BLACK FALCON AVENUE, BOSTON, MA, 02210, US

(21) Appl. No.: 12/015,063

(22) Filed: Jan. 16, 2008

Related U.S. Application Data
(60) Provisional application No. 60/889,372, filed on Feb. 12, 2007.

(51) Int. Cl. E04B 1/38; E06B 9/02

(52) U.S. Cl. 52/586.1; 52/745.21

(57) ABSTRACT

A hook for mounting a protective panel to a structure. The hook provides an angled extension that matches the top notch and the wider opening of a keyway in the top of the panel. The panel keyway engages the hook and slides down to a section where the top notch matches and seats onto a horizontal section of the hook. This horizontal section can be elongated to seat two or more panels with no vertical offset. The hook may be used to support any of the various types of protective panels, but the panels may be decorative or useful. The bottoms of the panels are secured to the structure by known methods.

### CROSS-REFERENCE TO RELATED APPLICATIONS

The present application claims the benefit of U.S. Provisional Patent Application Ser. No. 60/889,372, filed on Feb. 12, 2007, which provisional application is entitled, “Securing Method for Hurricane Protection Devices,” and which provisional application is hereby incorporated herein by reference. The present application is also related to a co-filed application entitled, Hurricane Panel Clip and Hook, of common ownership, inventorship, and which application is hereby incorporated herein by references.

### BACKGROUND OF THE INVENTION

1. Field of the Invention

The present invention relates to the protection of windows, doors and other openings from damage due to wind and windborne debris.

2. Background Information

Hurricanes, typhoons and cyclones all have high winds that can destroy structures due to the force of the wind alone, but also due to debris that impact property and humans.

Some building codes now include a standard for storm panels that can withstand severe impacts by large wind driven items. Standard panels made from clear polycarbonate are often 14 inches wide, 0.110 inches thick, fabricated under one or more standards from the American Society for Testing and Material. Some of these standards include: ASTM E1886, E1996, and E330 (cyclic and Static Wind Load and Impact Testing). Illustrative examples made in accordance with the present invention have been successfully tested by a qualified engineering laboratory and pass the aforementioned ASTM specifications.

U.S. Pat. No. 5,457,921 ('921) discloses use of corrugated polycarbonate panels mounted on aluminum or steel frames with thermal expansion room for the panels. The panels are overlapped, have apertures formed as keyway slots at the tops and bottoms, and are secured over areas of a structure, such as a window, to be protected. Screws extend through the narrow portions of the keyway slots and are tightened to secure the panels.

In some prior art applications the top of the panel is not secured to the structure. The top may be simply inserted into the open “n” portion of an “h” header. With respect to high winds such a mounting of protective panels would span a vertical distance of about 48 inches before reinforcement was necessary. It would be advantageous if the vertical distance before a panel needed re-enforcing were increased.

The '921 patent is hereby incorporated herein by reference. It also discusses the requirements to withstand high winds and debris impact.

U.S. Pat. No. 6,974,622 ('622) disclosed overlapped corrugated panels that have double re-enforced keyways. This patent is also incorporated herein by reference. This patent also discloses more detail on the specifics of windborne debris. Specifically, the panel should survive the impact of a missile weighing about 9.4 lbs (4.3 kgs), having a cross section impact area of about 5.25 sq. inches (34 square cm), and traveling at about 50 ft/sec (15.24 m/sec). However, the art disclosed in this patent also requires the installers' to climb a ladder to reach and screw tight the panels. This increases the time and decreases the safety of the prior art installation.

The prior art use of corrugated polycarbonate or other such protective panels still requires direct attachments at the top and bottom for maximum strength and spanned vertical distances. This means that an installer must reach the top of the panel (usually climbing a ladder) and install the upper screws into the support structure each time the panels are installed and removed. Moreover, when one or two or three panels are overlapped for added strength, the screws supporting the top (and the bottom) may be difficult to install.

The present invention addresses these and other limitations of the prior art.

### SUMMARY OF THE INVENTION

The present invention is directed to a hook attached to a structure and arranged to engage a keyway or hole in a protective panel. The panel may be of the corrugated polycarbonate described above, but the panel may also be made of metal, wood or materials and designs suitable for protecting the underlying structure from damage due to high winds and windborne debris.

The hook has a cross-section and an angled or sloped surface that engages and matches an aperture in the panel. The aperture is typically a keyway with a top notch that is narrower than the wider lower portion of the keyway. The panels or panels slide down the sloped surface of the hook and when the panel is pulled down and the top notches rest on a horizontal extension of the hook. Typically the cross section of the horizontal extension of the hook matches the keyway or at least part of the keyway to prevent rotation of the panel with respect to the hook. If the panels are doubled the horizontal extension of the hook may be made long enough to accept two or more panels. All the panel keyways rest on the horizontal section where there is no vertical offset of one panel to another, and in some applications the keyway may be re-enforced.

There may be one hook and keyhole along each lateral corrugation of a corrugated panel, or there may be one hook and keyhole every two to eight inches along the top of a panel with corresponding holes for attachment at the bottom.

In one illustrative embodiment the panel may be attached by an installer with access only to the bottom of the panel. The top of the panel is positioned above the hook to engage the keyhole. The panel is then pulled down engaging the hook and the keyhole. The bottom of the panel is then secured to the structure. The use of the present invention precludes climbing ladders to reach the top of the panels and has demonstrated as much as a 60% time savings to install hurricane panels. In an emergency, e.g. an approaching hurricane, the reduced time and effort to install hurricane panels according to the present invention could be critical to protection of property, livelihood, and personal safety.

An advantage of the present invention is that the vertical length of a panel before additional supports are necessary is approximately doubled with respect to the prior art. However, if the length still exceeded that longer length a lateral center support may be used, and the panels may be overlapped to increase strength.

### BRIEF DESCRIPTION OF THE DRAWINGS

The invention description below refers to the accompanying drawings, of which:

FIG. 1A is an isometric drawing of a panel assembly using the inventive hook;

FIG. 1B is an exploded view of an illustrative assembly;

FIG. 2 is a detail drawing of a keyway; and

FIGS. 3A, 3B and 3C are drawings showing details of the hook and panels as they engage each other.

### DETAILED DESCRIPTION OF AN ILLUSTRATIVE EMBODIMENT

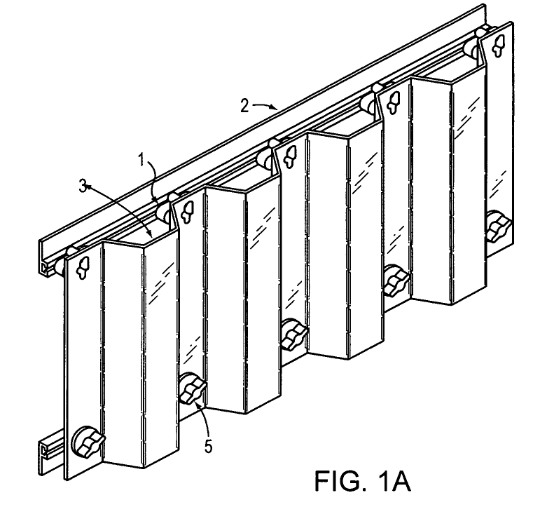

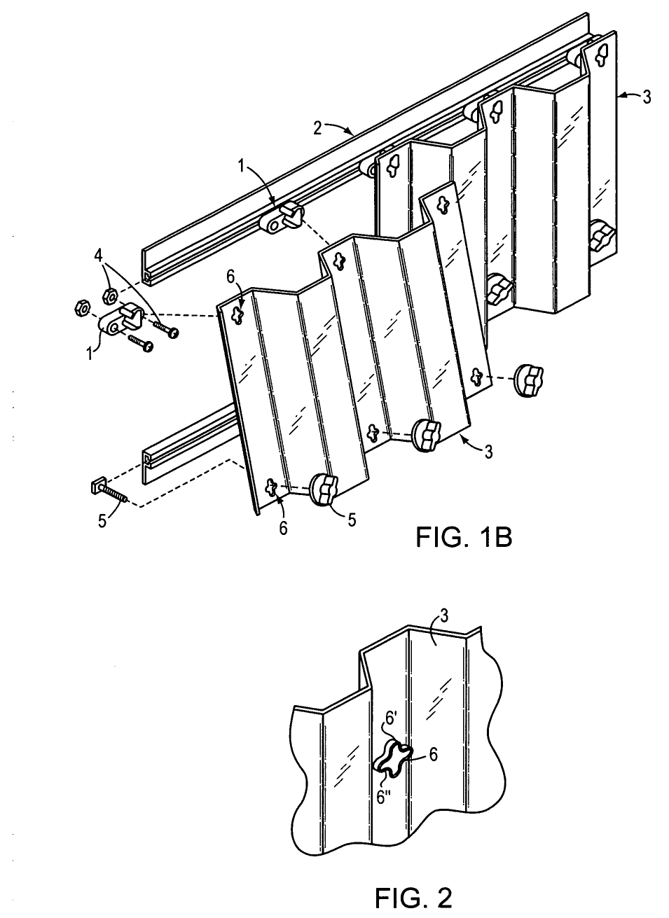

The drawings listed above illustrate a protective panel system that is typically used over doors, windows, and other glass or vulnerable areas of a structure. The protective system includes a storm panel 3 of FIGS. 1A and 1B that is held in place by a hook 1 at the top and track bolts and wing nuts 5 sized to fit keyholes 6 at the bottom of the panel. Using longer panels may include the use of an additional lateral support comprising track bolts and wing nuts (not shown) distributed laterally at the mid point of the panel. In practical applications the vertical length of the panels 3 may exceed 100 inches before the additional lateral support assembly is needed. In illustrative embodiments of FIG. 1B, the hook 1 may also be attached to a track 2 using standard nuts and bolts 4, though the hook may be screwed or bolted directly to the structure. Likewise the bottom track bolts and wing nuts 5 may be replaced and the bottom of the panel screwed directly to the structure, or permanently mounted fixtures known in the art, e.g., PANELMATES™, a Trademark of Pyramid Fasteners, see pyramidfasteners.com.

The protective or storm panels are commercially available in polycarbonate (plastic) and metal from Transparent Protections Systems, Inc of West Palm Beach, Fla. as well as other manufacturers. In other applications the protective panels may be made of any suitable protective material, including wood, metal, composites, or combinations thereof, etc., and need not be of a corrugated design.

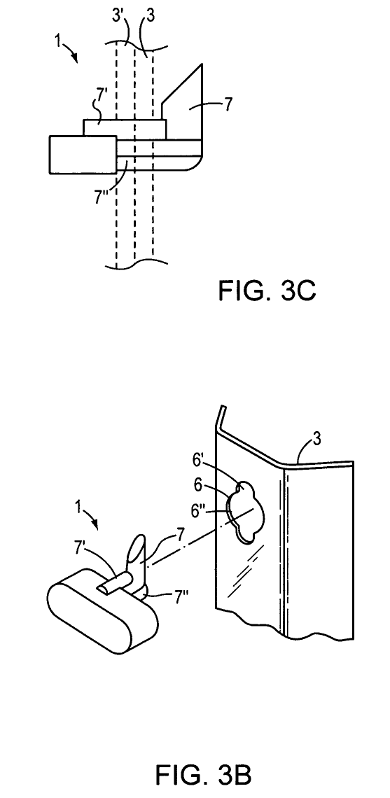

As mentioned above, the panels 3 may be overlapped for increased strength. Using the present invention the overlapping panels self align when mounted to the inventive hurricane hook and are mounted without accessing the top of the panels. From beneath, the panel is raised such that keyhole 6 at the top of the panel engages the hook 1. The panel is pulled down and the keyhole 6 rests on the horizontal extension 7′ shown in FIG. 3C. The horizontal extension 7′ may be wide enough to accept one, two 3 and 3′ or more panels, if desired. When mounted using the present invention there are no obvious changes to the appearance of the structure with respect to prior art mountings.

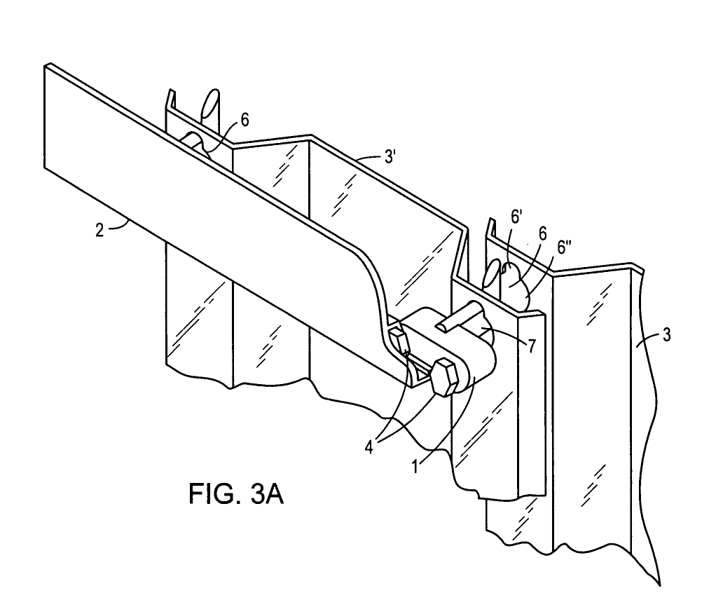

FIG. 2 shows a key way 6 with a narrower top notch 6,′ and a wider portion 6,″ and there may be a bottom notch.

FIG. 3A is a perspective, pictorial drawing illustrating two panels, 3 and 3′ being installed over a hook 1. The hook, as in FIGS. 3B and 3C, has an angled surface 7 that allows the panels 3 and 3′ to ease into position. The angled surface helps the panels into position when an installer pulls from the bottom of the panel. The track bolts 4 secure the hook to the track 2, and an additional track and nuts and bolts may be used to secure the bottom to ensure that the panel does not lift up during a hurricane.

Referring to FIGS. 1B and 3A, the hook 1 may be installed directly onto the structure being protected or a track 2 may be attached to the structure being protected and the hook attached to the track by track bolts or by screws and nuts. The track is a separate, usually metal, strip that is attached laterally along the window, door or other such opening to be protected. The track is designed to accept a track bolt that extends through the hook to secure the hook to the track (and thus to the structure) by a nut or a wing nut. Alternatively, a nut 4 may be placed in the track and a screw through the hook mates with the nut to secure the hook to the track.

There may be another track secured to the structure at the bottom of the panel. The panel may have through holes designed to accept a track bolt or screw and nut that secures the panel to the bottom of the panel to the structure. For long panels there may be a third track secured to the panel arranged about midway down the vertical length of the panel. As mentioned above, the present invention allows the panel length to be longer than 100 inches before a mid length lateral support is used.

In FIG. 3B illustrates the hook 1 has an angled surface 7 matches the top 6′ of the keyway 6, while the wider portion of the horizontal section 7″ matches the wider portion 6″ of the keyway 6. The key way 6 is lifted above the hook and lowered onto the angled surfaces of the hook that allows the keyway in the panel to ease into position. When the panel is seated, the cross section of the horizontal portion matches the keyway so that the panel sits securely without rotating or shifting vertically.

FIG. 3C is a side view of the hook where the panels slid down the angled surface 7 and seat on the horizontal section 7′. The cross section, as mentioned before, matches the keyway shape.

Typically the panels are raised above the hook and then lowered to engage the hook's sloping surface with the keyway. The panel then slides down the hook as it is pulled firmly down. The panels are then secured at the bottom of the panel. The installer need not climb a ladder to reach the top of the panel saving time and energy. Moreover, simply not using a ladder improves safety, and the panels may be installed very quickly without tools (wing nut attachments at the bottom of the panels) and with virtually no preparation or fore thought needed. These advantages result in a system that is ready and installed in a moment's notice.

When multiple panels are mounted on the same hook, the angled surface also helps the second panel slide into position.

The hook itself may be of a metal or polymer base, and it may be reinforced with fibers as known to those skilled in the art.

Although the disclosure herein is directed to securing protective panels to a structure, the inventive hook may be used to attach decorative, useful (say with shelves or pockets for storing items) or other types of panels.

What is claimed is:

1. A hook for attaching a panel to a structure, the hook comprising:
a body with a horizontal section that mates with a through aperture in the panel;
an angled upward extension from horizontal section; wherein the angled upward extension mates with the aperture, and wherein, when the angled upward extension engages the aperture, the panel may be pulled down with the aperture sliding on the angled upward extension until the aperture seats on the horizontal section.

2. The hook of claim 1 wherein the aperture comprises a keyway having a top notch that is narrower than the lower opening of the keyway, and wherein the angled upward section of the hook mates with the top notch.

3. The hook of claim 2 wherein the horizontal section mates with the top notch and the lower opening of the keyway.

4. The hook of claim 1 wherein when the aperture is seated on the horizontal section the keyway and the horizontal section mate such that the panel will not rotate with respect to the hook

5. A method for attaching a panel to a structure, the method comprising the steps of:
piercing the panel with an aperture;
attaching a hook to the structure; wherein the hook has a horizontal section that mates with the aperture, and wherein the hook has an angled upward extension from horizontal section; wherein the angled upward extension also mates with the aperture;
placing the aperture to engage the angled upward extension;
pulling down on the panel wherein the aperture slides down the angled upward extension until the aperture seats on the horizontal section.

6. The method of claim 5 wherein when the aperture engages the angled upward section of the hook, a narrow top section of the aperture engages a mating shape of the angled upward section, and wherein when the panel seats on the horizontal section, the horizontal section of the body mates with the narrow top notch section and with a wider lower opening of the keyway.
